(19) United States
(12) Patent Application Publication
(10) Pub. No.: US 2006/0034985 A1
(43) Pub. Date: Feb. 16, 2006

(54) Prawn preservative and method of preserving prawn

(75) Inventor: Nobuyuki Higuchi, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: ADVAN TOKYO CO., LTD., Tokyo (JP)

(21) Appl. No.: 11/201,165

(22) Filed: Aug. 11, 2005

(30) Foreign Application Priority Data
Aug. 13, 2004 (JP) P2004-235756

(51) Int. Cl. A23B 4/20

(52) U.S. Cl. 426/332

(57) ABSTRACT

The prawn preservative of the invention includes an ascorbic acid compound at effective concentration and a reducing sugar compound in a ratio of 0.1-1 to the ascorbic acid compound contained. The method of preserving a prawn according to the invention includes subjecting a prawn maintained in a living state, in a raw state not undergoing apparent denaturation after death, or in a raw state not undergoing apparent denaturation after the thaw from a frozen state to treatment by dipping in the range of 0.3 to 5 minutes in a prawn preservation treatment solution consisting of an aqueous solution having an ascorbic acid compound at effective concentration and a reducing sugar compound in a ratio of 0.1-1 to the ascorbic acid compound contained, and then preserving the prawn under refrigeration or freezing.

### BACKGROUND OF THE INVENTION

1. Field of the Invention

The present invention relates to a prawn preservative used for long-term storage without deteriorating the qualities of raw prawns.

2. Description of the Related Art

It is known that when crustaceans such as prawns and crabs among fishery products are captured and landed, a deterioration generally begins where the vital reaction is terminated, rigor mortis occurs, subsequent tissue oxidation occurs so that anntenae and shells are discolored and muscles are softened, resulting in decay. To prevent the progress of such deterioration, a method of freeze-preserving foods is generally adopted. However, even if prawns, particularly pink prawn, are preserved in a frozen state, tissues of the prawns once thawed undergo deterioration relatively rapidly, and thus it was considered preferable that the prawns after the thaw are cooked and consumed immediately, or are processed into preserved food.

Such frozen prawns after the thaw are sometimes preserved in a refrigerated state. However, there are also cases where raw prawns are preserved under mere refrigeration without being frozen prior to refrigerating the same and are consumed or cooked before their deterioration significantly advances. As the deterioration of prawn tissues advances even during such cooking at room temperature or storage, it is approved to use a sulfur dioxide-containing sulfite compound for prawns and crabs as a preservative for preventing the commodity value of prawns from falling off. Such sulfite compound has anti-oxidant power to prevent degradation such as darkening in prawn heads, antennae and legs or loss in gloss due to partial whitening of shells, and thus it is believed that a majority of frozen prawns and refrigerated prawns available on the market have been subjected to deterioration prevention treatment with preservatives containing sulfite compounds such as sulfites and pyrosulfites.

As such preservative containing a sulfite compound, an aqueous solution containing, for example, about 2% sodium pyrosulfite and about 1% erythorbic acid is used in many cases. Also used is an aqueous solution preservative thereof having a small amount of a phosphate such as sodium tripolyphosphate or sodium polyphosphate added thereto, or about 2 to 3% dextrin or the like compounded blended therein. Conventionally, such preservative in the form of an aqueous solution is stored in a dipping bath of relatively small capacity. Generally, prawns are scooped up from a fish collecting vessel where the prawns live after being captured, and then the prawns are put on a conveyer and picked out there to be sent to the above dipping bath where they are subjected to a short time dipping process, scooped up again, sent to a refrigerating step or a freezing step and shipped as refrigerated commodities or frozen commodities, respectively.

### SUMMARY OF THE INVENTION

The sulfite compound described above is known to be a potent reducing agent and approved to be used not only as a food additive for preservation but also as a bleaching agent and an antioxidant. Provided that the amount of used sulfite compound is kept low, the compound is considered nontoxic to health so its use is approved at a standard of less than 0.10 g/kg. in terms of the concentration of sulfur dioxide remaining in prawns etc. Basically, however, the sulfite compound itself is not a desirable chemical compound as food. In addition, prawns treated with a preservative containing the sulfite compound have problems such as discoloration and gloss deterioration of prawn shells and muscles, as well as disadvantages in tastes such as nasty taste and bitter taste.

The amount of the sulfite compound adhering to such frozen prawns can be quantitatively determined by, for example, subjecting the prawns to a dipping process in distilled water in about 5-fold excess in prawn weight at 15° C. or less for 5 minutes, then dipping a sulfite ion testing paper (QUANTOFIX Sulphite, MACHEREY NAGEL GmbH) in the resulting extract solution, comparing the color tone of the testing paper after 20 seconds dipping with a color sample, and measuring the concentration of the sulfite ion in the extract solution.

Accordingly, the object of the present invention is to provide a composition for preservation of prawns, which exhibits excellent performance to prevent darkening and is hygienically safe by using an organic material known as food or food additive in place of the conventionally used sulfite compound, and to further provide a prawn preservative based on this novel composition for preservation of prawns, which can solve not only problems such as deterioration in prawn color/gloss but also disadvantages such as deterioration in tastes.

The prawn preservative of the present invention includes an ascorbic acid compound at an effective concentration and a reducing sugar compound in a quantity of 0.1-1 times the ascorbic acid compound contained, and particularly preferably further includes an aqueous solution.

The method of preserving a prawn according to the present invention includes the steps of subjecting a prawn maintained in an living state, in a raw state not undergoing apparent postmortem deterioration, or in a raw state free from apparent after-thaw deterioration to a dipping treatment for a period of 0.3 to 5 minutes in a prawn preservation treatment solution including an aqueous solution containing an ascorbic acid compound at effective concentration and a reducing sugar compound in a quantity of 0.1-1 times the ascorbic acid compound contained therein, and then preserving the prawn under refrigeration or freezing.

Prawns which have been preserved under refrigeration or freezing after dipping treatment with the prawn preservative of the present invention, even under unfavorable conditions where they are left in an environment in the proximity of ordinary temperatures after the thaw, can have an effect of improving qualities thereof as food merchandise not only to exhibit a anti-deterioration effect which is at least equivalent to that of a preservative using a sulfite compound, with respect to darkening and whitening on heads, antennae and legs, but also to prevent the deterioration of red color/gloss unique to prawns and the denaturation of tastes, which cannot be avoided upon treatment with the sulfite compound.

### DESCRIPTION OF THE PREFERRED EMBODIMENTS

As the ascorbic acid compound as the first element in the prawn preservative of the present invention, one or more compounds selected from L-ascorbic acid, an L-ascorbic acid stereoisomer such as D-ascorbic acid called erythorbic acid, a salt thereof and an ester thereof can be used alone or in combination of two or more thereof, and it is particularly preferable that compounds selected from ascorbic acid and ascorbates are suitably selected and used.

As the reducing sugar compound as the second element in the prawn preservative of the present invention, not only monosaccharides but also sugars having a chemical structure acting as an aldehyde group or ketone group, such as maltose and lactose, are used. From the viewpoint of preservation effect and tastes, however, the reducing sugar compound is preferably a member selected from monosaccharides, among which fructose, glucose, sorbitol etc. are particularly preferably used.

Preferably, the ascorbic acid compound and the reducing sugar compound in the prawn preservative of the present invention are prepared as a preservative in the form of an aqueous mixed solution thereof, in which prawns are dipped and treated for preservation. Its inhibitory effect on darkening subsequent to the deterioration of prawns is approximately determined mainly by the concentration of the ascorbic acid compound contained, and usually an aqueous solution containing the ascorbic acid compound at 1% or more is preferably used. However, a concentration higher than 5% ascorbic acid compound is uneconomic and gives rise to significant tendency for discoloration of prawns, and is thus not recommended.

The reducing sugar compound, when used alone, hardly exhibits an effect of preventing the darkening of prawns, but the present inventors have found for the first time that when the reducing sugar compound is allowed to be coexistent in a quantity 0.1-1 times the ascorbic acid compound used, the discoloration of prawns and the deterioration of color/gloss are suppressed, and simultaneously tastes are also improved, and an amount outside of this range is not preferable because when the amount of the reducing sugar compound used is lower than this range, its effect is not evident, while too large an amount results in a reduction in the inhibitory effect on darkening.

The effective concentration of the ascorbic acid compound in the prawn preservative of the present invention is varied depending on the type and freshness of prawn as the subject of treatment, but is preferably at least about 1 to 1.5% as a concentration in an aqueous solution. However, when it is estimated the environment where prawns are preserved is not in a cool atmosphere, the concentration of the ascorbic acid compound in the preservative treatment solution is preferably about 2 to 3%, and accordingly the concentration of the reducing sugar compound in the treatment solution may be about 0.5 to 2%.

It is most preferable that as prawns to be subjected to preservation treatment with the prawn preservative of the present invention, living prawns just after capture or prawns maintained and raised in an excellent controlled environment after capture are scooped up and immediately subjected to a dipping treatment in the range of 0.3 to 5 minutes. However, raw prawns in a state still not reaching rigor mortis can be subjected to a dipping treatment, or prawns which has been frozen alive to prevent the postmortem rigor can be subjected to a simultaneous thawing and dipping treatment to achieve a reasonable though not perfect effect of preventing deterioration.

The prawns which were subjected to dipping treatment with the prawn preservative of the present invention are preferably immediately frozen if long-term preservation is desired, and the deterioration in qualities of prawns preserved in a frozen state in a clean and dark place is almost completely negligible. Accordingly, the deterioration in qualities of the prawns after preservation treatment are considered to be influenced by the preserving environment after the thaw of the prawns, particularly by oxidizing substances in the atmosphere, preserving temperature, lighting etc., and thus the prawns are kept preferably in a refrigerator even in short-time preservation.

The type of prawn subjected to preservation treatment with the prawn preservative of the present invention is not particularly limited, but tastes are particularly important for prawns such as pink prawns and their red color is an important quality evaluation item, so that as a prawn preservative capable of eliminating the drawbacks of the prawn preservative using a sulfite compound, the prawn preservative of the present invention can be particularly preferably used for pink prawns.

### EXAMPLE 1

Pink prawns living in the sea bottom about 300 to 400 m below sea level were captured with a trawl net, and maintained and raised in a fish tank filled with seawater at a temperature of 2 to 5° C. Separately, 3 kinds of compounds, that is, L-ascorbic acid (ASCA), sodium ascorbate (ASCN) and erythorbic acid (ETBA) were used as the ascorbic acid compound and fructose (FRU) was used as the reducing sugar compound, and these compounds were dissolved respectively in water to have the respective concentrations (g/dl) shown in Table 1, to prepare preservation treatment solutions different in composition from one another. Then, each of these preservation treatment solutions was used in preservation treatment of the above living pink prawns, and each of the treated prawns was subjected to a quality deterioration test to examine the relationship between the composition of the preservation treatment solution and the performance of preserving the prawns.

(Method for Preservation Treatment of Prawns)

The pink prawns in the fish tank were scooped up to swish off the water and, thereafter, they were dipped for 1 minute in the preservation treatment solution at a temperature of about 4 to 15° C. in a treatment bath, then scooped up, immediately placed in a freezer at −18° C., and stored in a frozen state.

(Method of Measuring the Deterioration of Prawns)

The 10 pink prawns stored for at least 16 hours in the above freezer were thawed in running water (tap water) at a temperature of 15 to 20° C., and the pink prawns reaching 20° C. were arranged on a kitchen paper spread in a square-shaped vat, and examined in an accelerated deterioration test with time for about 10 hours under indirect lighting with a white fluorescent lamp in a room at a temperature of 21 to 24° C., and the darkening of the prawns with shells and a reduction in the color/gloss thereof were observed. Thereafter, a reduction in the meat color of the prawns was observed, and the meat was tasted with the tongue to examine whether or not it tastes bitter or nasty. Each of these examination items was evaluated and scored independently by 5 persons based on the evaluation criteria described below, and the average evaluation point was rounded off and shown together with the total point in the section “Preservation results” in Table 1.

Evaluation criteria of the degree of darkening, color/gloss state, reduction in-meat color, and the presence or absence of bitter taste and nasty taste after 10 hours, used as evaluation items for judging the extent of deterioration of the prawns were given a 5-rank rating of from point 4 to point 0. Accordingly, it is meant that if the point in every examination item is point 2 or more, prawn food is obtained as having no particular defect is obtained.
Point 4: Maintaining a state equivalent to or not inferior to that of living prawns (very excellent).
Point 3: Being approximately equivalent to that of frozen prawns just after the thaw (excellent).
Pointe 2: Being equivalent to a state without remarkable defects after the thaw of a usual frozen product (good).
Point 1: Having apparent defects (off-grade).
Point 0: Being unsuitable as food (rejected).

As the control preservative for comparison, two kinds of conventional products based on a sulfite compound, that is, conventional product A (CMPA) consisting of 65% sodium pyrosulfite and 35% erythorbic acid and conventional product B (CMPB) having a composition consisting of 40% sodium pyrosulfite, 20% erythorbic acid and 40% dextrin were prepared and dissolved respectively in water in different concentrations to prepare preservation treatment solutions. Then, pink prawns were subjected to dipping treatment therewith in the same manner as described above and stored under freezing. The frozen pink prawns were thawed in the same manner as described above, examined in a deterioration test and evaluated in each examination item, and preservation results were examined respectively and shown collectively in Table 1.

TABLE 1
Composition of the preservative and preservation effect on fresh
pink prawns (accelerated deterioration test: 21 to 24° C., 10 hrs)

| | | | | | | | Preservation results | | | | |
|---|---|---|---|---|---|---|---|---|---|---|---|
| | Concentration of chemical | | | | | | | | | Bitter | |
| | for dipping treatment | | | | | | | | | taste/ | Total |
| Test | of prawns (g/dL) | | | | | | Meat | | Color/ | Nasty | point |
| No. | ASCA | ASCN | ETBA | FRU | CMPA | CMPB | color | Darkening | gloss | taste | (s) |
| 1* | — | — | — | — | — | — | 0 | 0 | 1 | 0 | 1 |
| 2* | 4.0 | — | — | — | — | — | 4 | 1 | 1 | 1 | 7 |
| 3* | 3.5 | — | — | — | — | — | 4 | 1 | 1 | 1 | 7 |
| 4* | 3.0 | — | — | — | — | — | 4 | 2 | 1 | 1 | 8 |
| 5* | 2.5 | — | — | — | — | — | 4 | 2 | 2 | 2 | 10 |
| 6* | 2.0 | — | — | — | — | — | 3 | 2 | 2 | 2 | 9 |
| 7* | 1.5 | — | — | — | — | — | 2 | 2 | 1 | 1 | 6 |
| 8* | 1.0 | — | — | — | — | — | 1 | 1 | 1 | 1 | 4 |
| 9* | 0.5 | — | — | — | — | — | 1 | 0 | 1 | 1 | 3 |
| 10 | 2.5 | — | — | 0.5 | — | — | 4 | 4 | 3 | 3 | 14 |
| 11 | 2.0 | — | — | 1.0 | — | — | 3 | 3 | 3 | 3 | 12 |
| 12 | 1.5 | — | — | 1.5 | — | — | 2 | 2 | 2 | 2 | 8 |
| 13 | 1.0 | — | — | 2.0 | — | — | 1 | 1 | 1 | 2 | 5 |
| 14 | 0.5 | — | — | 2.5 | — | — | 1 | 1 | 1 | 1 | 4 |
| 15* | — | — | — | 3.0 | — | — | 0 | 0 | 1 | 1 | 2 |
| 16* | — | 3.0 | — | — | — | — | 3 | 1 | 1 | 1 | 6 |
| 17* | — | 2.5 | — | — | — | — | 3 | 2 | 1 | 1 | 7 |
| 18* | — | 2.0 | — | — | — | — | 2 | 2 | 2 | 1 | 7 |
| 19* | — | 1.5 | — | — | — | — | 1 | 1 | 1 | 1 | 4 |
| 20* | — | 1.0 | — | — | — | — | 0 | 1 | 1 | 0 | 2 |
| 21 | — | 2.5 | — | 0.5 | — | — | 3 | 3 | 2 | 3 | 11 |
| 22 | — | 2.0 | — | 1.0 | — | — | 3 | 2 | 2 | 3 | 10 |
| 23 | — | 1.5 | — | 1.5 | — | — | 2 | 1 | 2 | 2 | 7 |
| 24 | — | 1.0 | — | 2.0 | — | — | 1 | 1 | 1 | 1 | 4 |
| 25* | — | — | 3.0 | — | — | — | 3 | 1 | 1 | 1 | 6 |
| 26* | — | — | 2.5 | — | — | — | 3 | 2 | 2 | 1 | 8 |
| 27* | — | — | 2.0 | — | — | — | 2 | 2 | 1 | 1 | 6 |
| 28* | — | — | 1.5 | — | — | — | 1 | 1 | 1 | 1 | 4 |
| 29* | — | — | 1.0 | — | — | — | 1 | 0 | 1 | 1 | 3 |
| 30 | — | — | 2.5 | 0.5 | — | — | 3 | 3 | 2 | 3 | 11 |
| 31 | — | — | 2.0 | 1.0 | — | — | 3 | 3 | 2 | 3 | 11 |
| 32 | — | — | 1.5 | 1.5 | — | — | 2 | 2 | 2 | 2 | 8 |
| 33 | — | — | 1.0 | 2.0 | — | — | 1 | 2 | 1 | 1 | 5 |
| 34* | — | — | — | — | 3.0 | — | 4 | 3 | 2 | 1 | 10 |
| 35* | — | — | — | — | 2.0 | — | 4 | 3 | 2 | 1 | 10 |
| 36* | — | — | — | — | 1.0 | — | 2 | 1 | 1 | 1 | 5 |
| 37* | — | — | — | — | — | 4.0 | 4 | 3 | 2 | 1 | 10 |
| 38* | — | — | — | — | — | 3.0 | 4 | 3 | 2 | 1 | 10 |
| 39* | — | — | — | — | — | 2.0 | 2 | 2 | 2 | 1 | 7 |
| 40* | — | — | — | — | — | 1.0 | 1 | 1 | 1 | 1 | 4 |

*Comparative control example
ASCA: L-ascorbic acid;
ASCN: sodium ascorbate;
ETBA: erythorbic acid;
FUR: fructose;
CMPA: 65% sodium pyrosulfite + 35% erythorbic acid;
CMPB: 40% sodium pyrosulfite + 20% erythorbic acid + 40% dextrin

As can be seen from the results in Table 1 above, the pink prawns frozen after dipping in the conventional sulfite compound-containing preservation treatment solution in which erythorbic acid among the ascorbic acid compounds is used in combination with sodium pyrosulfite at a chemical concentration of at least about 2 g/dl exhibit an excellent effect with respect to prevention of darkening and maintenance of color/gloss, as compared with the deteriorated state (data in Test No. 1) of the untreated fresh pink prawns after 10 hours, but generate a bitter taste etc. to deteriorate the tastes as fresh pink prawns (see data in Test Nos. 34 to 40), while the pink prawns treated with a preservation treatment solution using L-ascorbic acid, sodium ascorbate or erythorbic acid singly among the ascorbic acid compounds are inferior in prevention of darkening and maintenance of color/gloss to those treated with the conventional preservation treatment solution containing the sulfite compound, generate a nasty taste instead of bitter taste, and cannot prevent the reduction of color/gloss or meat color at a chemical concentration of 2 to at least 2.5 g/dl (see data in Test Nos. 2 to 9, 16 to 20 and 25 to 29).

However, it was found that the above phenomenon of degradation in qualities of pink prawns when the ascorbic acid compound is singly used is significantly improved by using the ascorbic acid compound in combination of fructose as a typical reducing sugar compound, and also that the concentration of the ascorbic acid compound in the preservation treatment solution is preferably about 1.5 g/dl or more. That is, the aqueous solution of fructose is not effective as the preservation treatment solution (data in Test No. 15), while any preservation treatment solutions using fructose in combination with L-ascorbib acid (see data in Test Nos. 10 to 14), in combination with sodium ascorbate (see data in Test Nos. 21 to 24) or in combination with erythorbic acid (see data in Test Nos. 30 to 33) are not significantly different in the darkening prevention effect from the treatment solution using the ascorbic acid compound singly, but can solve the deterioration of color/gloss and meat color as compared with the solution using the sulfite compound and can improve, to a satisfactory level, the taste change accompanying use of the ascorbic acid compound.

### EXAMPLE 2

Preservation treatment solutions were prepared in the same manner as in Example 1 except that L-ascorbic acid (ASCA) selected as the ascorbic acid compound, fructose (FRU), glucose (GLC), xylose (XYL), sorbitol (SOL) andmaltose (MAL) selected as the reducing sugar compound, and sucrose (SUC) and dextrin (DEX) selected as other sugar compounds were compounded according to the compositions shown in Table 2. Each of these preservations was used in preservation treatment of the living pink prawns, and each of the treated pink prawns was examined for their qualities in the deterioration test and evaluated in the same manner as in Example 1 to examine the relationship between the composition of each preservation treatment solution and the performance of preserving the prawns, and the results are shown in Table 2.

TABLE 2
Composition of the preservative and preservation effect on fresh
pink prawns (accelerated deterioration test: 21 to 24° C., 10 hrs)

| | | | | | | | | | Preservation results | | | | |
|---|---|---|---|---|---|---|---|---|---|---|---|---|---|
| | Concentration of chemical | | | | | | | | | | | Bitter | |
| | priximity for dipping | | | | | | | | | | | taste/ | Total |
| Test | treatment of prawns (g/dL) | | | | | | | | | Color/ | Meat | Nasty | point |
| No. | ASCA | FRU | GLU | XYL | SOL | MAL | SUC | DEX | Darkening | gloss | color | taste | (s) |
| 5* | 2.5 | — | — | — | — | — | — | — | 4 | 2 | 2 | 2 | 10 |
| 6* | 2.0 | — | — | — | — | — | — | — | 3 | 2 | 2 | 2 | 9 |
| 7* | 1.5 | — | — | — | — | — | — | — | 2 | 2 | 1 | 1 | 6 |
| 8* | 1.0 | — | — | — | — | — | — | — | 1 | 1 | 1 | 1 | 4 |
| 9* | 0.5 | — | — | — | — | — | — | — | 1 | 0 | 1 | 1 | 3 |
| 10 | 2.5 | 0.5 | — | — | — | — | — | — | 4 | 4 | 3 | 3 | 14 |
| 11 | 2.0 | 1.0 | — | — | — | — | — | — | 3 | 3 | 3 | 3 | 12 |
| 12 | 1.5 | 1.5 | — | — | — | — | — | — | 2 | 2 | 2 | 2 | 8 |
| 13 | 1.0 | 2.0 | — | — | — | — | — | — | 1 | 1 | 1 | 2 | 5 |
| 14 | 0.5 | 2.5 | — | — | — | — | — | — | 1 | 1 | 1 | 1 | 4 |
| 41 | 2.5 | — | 0.5 | — | — | — | — | — | 4 | 4 | 3 | 3 | 14 |
| 42 | 2.0 | — | 1.0 | — | — | — | — | — | 3 | 3 | 3 | 3 | 12 |
| 43 | 1.5 | — | 1.5 | — | — | — | — | — | 2 | 2 | 2 | 2 | 8 |
| 44 | 1.0 | — | 2.0 | — | — | — | — | — | 1 | 1 | 1 | 1 | 4 |
| 45 | 0.5 | — | 2.5 | — | — | — | — | — | 1 | 1 | 0 | 1 | 3 |
| 46 | 2.5 | — | — | 0.5 | — | — | — | — | 4 | 3 | 2 | 2 | 11 |
| 47 | 2.0 | — | — | 1.0 | — | — | — | — | 3 | 3 | 2 | 2 | 10 |
| 48 | 1.5 | — | — | 1.5 | — | — | — | — | 2 | 2 | 1 | 1 | 6 |
| 49 | 1.0 | — | — | 2.0 | — | — | — | — | 1 | 1 | 1 | 0 | 3 |
| 50 | 2.5 | — | — | — | 0.5 | — | — | — | 4 | 3 | 2 | 2 | 11 |
| 51 | 2.0 | — | — | — | 1.0 | — | — | — | 3 | 3 | 2 | 2 | 10 |
| 52 | 1.5 | — | — | — | 1.5 | — | — | — | 2 | 2 | 2 | 1 | 7 |
| 53 | 1.0 | — | — | — | 2.0 | — | — | — | 1 | 0 | 1 | 0 | 2 |
| 54 | 2.5 | — | — | — | — | 0.5 | — | — | 4 | 4 | 3 | 2 | 13 |
| 55 | 2.0 | — | — | — | — | 1.0 | — | — | 3 | 3 | 2 | 2 | 10 |
| 56 | 1.5 | — | — | — | — | 1.5 | — | — | 2 | 2 | 1 | 1 | 6 |
| 57 | 1.0 | — | — | — | — | 2.0 | — | — | 1 | 0 | 1 | 1 | 3 |
| 58* | 2.5 | — | — | — | — | — | 0.5 | — | 4 | 2 | 2 | 2 | 10 |
| 59* | 2.0 | — | — | — | — | — | 1.0 | — | 3 | 2 | 2 | 2 | 9 |
| 60* | 1.5 | — | — | — | — | — | 1.5 | — | 2 | 2 | 1 | 1 | 6 |
| 61* | 1.0 | — | — | — | — | — | 2.0 | — | 1 | 1 | 1 | 0 | 3 |
| 62* | 2.5 | — | — | — | — | — | — | 0.5 | 4 | 2 | 2 | 2 | 10 |
| 63* | 2.0 | — | — | — | — | — | — | 1.0 | 3 | 2 | 2 | 1 | 8 |
| 64* | 1.5 | — | — | — | — | — | — | 1.5 | 1 | 1 | 1 | 1 | 4 |
| 65* | 1.0 | — | — | — | — | — | — | 2.0 | 1 | 1 | 1 | 1 | 4 |
| 66* | — | — | — | — | — | — | — | 2.0 | 0 | 0 | 1 | 0 | 1 |

*Comparative control example
ASCA: L-ascorbic acid;
FRU: fructose;
GLU: glucose;
XYL: xylose;
SOL: sorbitol;
MAL: maltose;
SUC: sucrose; and
DEX: dextrin.

As can be seen from the results in Table 2, the preservation treatment solutions of the present invention having L-ascorbic acid as a typical ascorbic acid compound compounded in combination with a reducing sugar compound can compensate for the drawback of the preservation treatment solutions using L-ascorbic acid only, but the preservation treatment solutions using L-ascorbic acid in combination with a non-reducing sugar compound such as sucrose and dextrin cannot achieve the effect described above. It can be seen that the preferable effect can be achieved if the weight ratio of the reducing sugar compound to the ascorbic acid compound in the preservation treatment solution of the present invention is in the range of about 0.1 to 1.

### EXAMPLE 3

L-ascorbic acid (ASCA) and erythorbic acid (ETBA) were selected as the ascorbic acid compound; fructose (FRU), glucose (GLC) and maltose (MAL), as the reducing sugar compound, sucrose (SUC), dextrin (DEX) and crude sucrose (CCS), as other sugar compounds and sodium polyphosphate (PPFN); and further sodium pyrosulfite (PSFN) as other food additives were used. Such compounds were concocted as shown in Table 3 to prepare Preservatives PX1 to PX9 in the present invention and Preservatives PX10 to PX11 as control examples. These preservatives were dissolved in water at the concentrations (g/dL) shown in Table 4 to prepare the preservative treatment solutions respectively.

Each of these preservative treatment solutions was used in preservation treatment of the living pink prawns in the same manner as in Example 1, and each of the treated pink prawns was subjected to the accelerated deterioration test in the same manner as described above and evaluated in the same manner as described above to examine the relationship between the composition of each preservation treatment solution and the performance of preserving the prawns, and the results are shown in Table 4.

TABLE 3
Preservative composition

| | Composition of prawn | | | | | | | | | | |
|---|---|---|---|---|---|---|---|---|---|---|---|
| Preservation | preservative (parts by weight) | | | | | | | | | | |
| symbol | ASCA | ETBA | FRU | GLU | MAL | DEX | SUC | CCS | PPFN | PSFN | Total |
| PX1 | 2.4 | — | 0.5 | 0.1 | — | — | — | — | — | — | 3.0 |
| PX2 | 2.4 | — | 0.5 | 0.1 | — | 1.0 | — | — | — | — | 4.0 |
| PX3 | 2.4 | — | 0.3 | — | 0.3 | — | — | — | — | — | 3.0 |
| PX4 | 2.4 | — | 0.3 | — | 0.3 | 1.0 | — | — | — | — | 4.0 |
| PX5 | 2.4 | — | 0.3 | — | — | — | 0.3 | — | — | — | 3.0 |
| PX6 | 2.4 | — | 0.3 | — | — | — | — | 0.3 | — | — | 3.0 |
| PX7 | 2.4 | — | 0.4 | 0.2 | — | 1.0 | 2.0 | — | — | — | 6.0 |
| PX8 | 1.0 | 1.2 | 0.5 | — | — | — | — | — | — | 0.3 | 3.0 |
| PX9* | 1.4 | 1.0 | — | — | — | 1.0 | — | — | 0.6 | — | 4.0 |
| PX10* | — | — | — | — | — | — | — | — | 0.6 | 2.4 | 3.0 |
| PX11* | — | 1.2 | — | — | — | 1.0 | — | — | 0.6 | 1.2 | 4.0 |

*Comparative control example
ASCA: L-ascorbic acid;
ETBA: erythorbic acid;
FRU: fructose;
GLU: glucose;
MAL: maltose;
DEX: dextrin;
SUC: sucrose;
CCS: crude sucrose;
PPFN: sodium polyphosphate;
PSFN: sodium pyrosulfite.

TABLE 4
Used concentration of preservative (g/dL) and preservation
effect (Accelerated deterioration test: 21 to 24° C., 10 hrs)

| | | | Preservation results | | | | |
|---|---|---|---|---|---|---|---|
| | | Used | | | | Bitter | |
| | Preservative | concentration | | | Meat | taste/nasty | Total |
| Test No. | symbol | (g/dL) | Darkening | Color/gloss | color | taste | point(s) |
| 67 | PX1 | 3.0 | 4 | 4 | 3 | 3 | 14 |
| 68 | PX1 | 2.0 | 3 | 3 | 2 | 2 | 10 |
| 69 | PX1 | 1.0 | 0 | 0 | 1 | 0 | 1 |
| 70 | PX2 | 4.0 | 4 | 4 | 3 | 3 | 14 |
| 71 | PX2 | 2.5 | 3 | 3 | 2 | 2 | 10 |
| 72 | PX2 | 1.0 | 0 | 0 | 1 | 1 | 2 |
| 73 | PX3 | 3.0 | 4 | 4 | 2 | 2 | 12 |
| 74 | PX3 | 2.0 | 3 | 2 | 2 | 2 | 9 |
| 75 | PX3 | 1.0 | 0 | 0 | 1 | 0 | 1 |
| 76 | PX4 | 4.0 | 4 | 4 | 2 | 2 | 12 |
| 77 | PX4 | 2.5 | 3 | 2 | 2 | 2 | 9 |
| 78 | PX4 | 1.0 | 0 | 0 | 1 | 1 | 2 |
| 79 | PX5 | 3.0 | 4 | 2 | 2 | 2 | 10 |
| 80 | PX5 | 2.0 | 3 | 2 | 1 | 1 | 7 |
| 81 | PX5 | 1.0 | 0 | 0 | 1 | 0 | 1 |
| 82 | PX6 | 3.0 | 4 | 3 | 3 | 2 | 12 |
| 83 | PX6 | 2.0 | 3 | 2 | 2 | 2 | 9 |
| 84 | PX6 | 1.0 | 0 | 0 | 0 | 0 | 0 |
| 85 | PX7 | 6.0 | 4 | 4 | 3 | 3 | 14 |
| 86 | PX7 | 4.0 | 3 | 3 | 2 | 1 | 9 |
| 87 | PX7 | 2.0 | 0 | 0 | 1 | 1 | 2 |
| 88 | PX8 | 3.0 | 4 | 4 | 3 | 2 | 13 |
| 89 | PX8 | 2.0 | 3 | 3 | 2 | 1 | 9 |
| 90 | PX8 | 1.0 | 0 | 0 | 1 | 0 | 1 |
| 91 | PX9* | 4.0 | 4 | 2 | 2 | 2 | 10 |
| 92 | PX9* | 2.5 | 3 | 2 | 1 | 1 | 7 |
| 93 | PX9* | 1.0 | 0 | 0 | 1 | 1 | 2 |
| 94 | PX10* | 4.0 | 4 | 2 | 2 | 1 | 9 |
| 95 | PX10* | 2.5 | 3 | 2 | 1 | 1 | 7 |
| 96 | PX10* | 1.0 | 0 | 0 | 1 | 0 | 1 |
| 97 | PX11* | 3.0 | 4 | 2 | 3 | 1 | 10 |
| 98 | PX11* | 2.0 | 3 | 2 | 1 | 1 | 7 |
| 99 | PX11* | 1.0 | 1 | 0 | 1 | 0 | 2 |

*Comparative control example

From the results in Tables 3 and 4, it can be seen that the preservatives (that is, PS1 to PX7) of the present invention containing an ascorbic acid compound and a reducing sugar compound in a ratio of about 0.1 to 0.2 to the ascorbic acid compound, when used in prawn treatment as aqueous preservation treatment solutions containing the ascorbic acid compound at a concentration of about 2.4 g/dL, can exhibit particularly excellent preservation results as compared with the results of preservation of prawns by using, as aqueous preservation treatment solutions, Comparative Preservative PS10 using sodium pyrosulfite (PSFN) and sodium polyphosphate (PPFN) and Comparative Preservative PX11 having erythorbic acid (ETBA) and dextrin (DEX) compounded with Preservative PX10. It can also be seen that drawbacks in meat color and generation of bitter taste/nasty taste occurring in the comparative preservatives do not occur in the preservative of the present invention even if it is used as an aqueous preservation treatment solution containing the ascorbic acid compound at a concentration of ⅔ of the above, that is, at a concentration of 1.6 g/dL.

Even if the preservatives of the present invention contain other sugar compounds such as sucrose (SUC), dextrin (DEX), crude sucrose (CCS) etc. or sodium pyrosulfite (PSFN) etc., there is no particular hindrance (PX2, PX4, PX5, PX6, PX7, PX8 etc.), but it was found that when a part of the reducing sugar compounds is replaced (PX5), the results are poor, and also that the reducing sugar compound-free preservative (PX9) based on the ascorbic acid compound exhibits preservation results approximately equivalent to those of the comparative preservatives.

The prawn preservative of the present invention is a chemical which includes a composition having a combination of an ascorbic acid compound and a reducing sugar compound known as food additive or food, is used in freeze-storing raw prawns without deteriorating the qualities thereof, and inhibits a deterioration phenomenon of partial darkening and whitening of shells during storage after the thaw of frozen prawns. Preservatives based on a sulfite compound used conventionally in preservation of prawns have the disadvantage of deterioration in the tastes of prawns, while the prawn preservative of the present invention when used as an aqueous solution for dipping treatment of prawns can prevent the deterioration of shell color/gloss and meat color, can prevent reduction in tastes, and can exhibit performance of inhibiting darkening and whitening not inferior to that of the conventional preservative, and thus there is an advantage of avoiding use, as a preservative, of a sulfite compound with anxiety about health.

1: A prawn preservative comprising an ascorbic acid compound at effective concentration and a reducing sugar compound in a ratio of 0.1-1 to the ascorbic acid compound contained.

2: The prawn preservative according to claim 1, wherein the ascorbic acid compound is a member selected from the group consisting of ascorbic acid, erythorbic acid, salts thereof and esters thereof.

3: The prawn preservative according to claim 1, wherein the reducing sugar compound is selected from monosaccharides.

4: The prawn preservative according to claim 1, which is in the form of an aqueous solution.

5: A method of preserving a prawn, which comprises subjecting a prawn maintained in a living state, in a raw state not undergoing apparent denaturation after death, or in a raw state not undergoing apparent denaturation after the thaw from a frozen state to treatment by dipping in the range of 0.3 to 5 minutes in a prawn preservation treatment solution consisting of an aqueous solution comprising an ascorbic acid compound at effective concentration and a reducing sugar compound in a ratio of 0.1-1 to the ascorbic acid compound contained, and then preserving the prawn under refrigeration or freezing.

6: The method of preserving a prawn according to claim 5, wherein the prawn is pink prawn.

7: The prawn preservative according to claim 2, wherein the reducing sugar compound is selected from monosaccharides.

8: The prawn preservative according to claim 2, which is in the form of an aqueous solution.

9: The prawn preservative according to claim 3, which is in the form of an aqueous solution.

10: The prawn preservative according to claim 7, which is in the form of an aqueous solution.
